(19) United States
(12) Patent Application Publication
(10) Pub. No.: US 2011/0183182 A1
(43) Pub. Date: Jul. 28, 2011

(54) GALVANIC ELEMENT WITH SHORT CIRCUIT FUSE PROTECTION

(75) Inventors: Thomas Woehrle, Stuttgart (DE); Rainer Hald, Ellwangen (DE); Markus Pompetzki, Ellwangen (DE); Markus Kohlberger, Ellwangen (DE); Johannes Maier, Ellwangen (DE); Calin Wurm, Ellwangen (DE); Arno Perner, Ellwangen (DE); Peter Haug, Ellwangen (DE); Dejan Ilic, Ellwangen (DE)

(73) Assignee: VARTA Microbattery GmbH, A Corporation of Germany, Hannover (DE)

(21) Appl. No.: 12/513,375

(22) PCT Filed: Nov. 6, 2007
(86) PCT No.: PCT/EP2007/009590

§ 371 Date: Apr. 14, 2010

(30) Foreign Application Priority Data
Nov. 6, 2006 (DE) 10 2006 053 273.2

(51) Int. Cl. H01M 10/02; H01M 4/64; H01M 2/00; H01M 2/14; H01M 4/583; H01M 4/52

(52) U.S. Cl. 429/149; 429/211; 429/188; 429/163

(57) ABSTRACT

A galvanic element includes at least one single cell having electrodes arranged on a substantially flat separator, at least one of which has a current collector provided with an output lug overlapping an edge area of the separator, with at least one thin layer being arranged in this edge area such that direct mechanical contact is prevented between the output lug and the separator.

### RELATED APPLICATIONS

This is a §371 of International Application No. PCT/EP2007/009590, with an international filing date of Nov. 6, 2007 (WO 2008/055647 A1, published May 15, 2008), which is based on Germany Patent Application No. 102006053273.2, filed Nov. 6, 2006.

### TECHNICAL FIELD

This disclosure relates to a galvanic element, comprising at least one individual cell having electrodes which are arranged on a flat separator, at least one of which has a current collector which is provided with an output lug which overlaps an edge area of the separator.

### BACKGROUND

Galvanic elements such as lithium-ion cells and lithium-polymer cells in many cases contain a cell stack which comprises a plurality of individual cells. The individual cells or individual elements from which a cell stack such as this is composed are in general a composite of active electrode films, preferably metallic collectors in each case arranged between two electrode halves (in general aluminum collectors, in particular composed of aluminum metal mesh or perforated aluminum foil for the positive electrode, and copper collectors, in particular composed of a massive copper foil, for the negative electrode) and one or more separators. Individual cells such as these are frequently produced as so-called bicells with the possible sequences negative electrode/separator/positive electrode/separator/negative electrode, or positive electrode/separator/negative electrode/separator/positive electrode.

Electrodes are generally produced by intensively mixing active materials, electrode binders such as the copolymer polyvinylidenefluoride hexafluoropropylene (PVDF-HFP) and possibly additives such as conductivity improvers and constituents of a softener, in many case dibutylphthalate (DBP) in an organic solvent such as acetone, drawing this out to form a sheet and applying it to a suitable collector. The electrode sheets formed in this way and provided with collectors are then applied, for example by means of a lamination process, to preferably very thin flat separators, in particular to sheet separators, and are thus processed to form the abovementioned individual cells, in particular to form the abovementioned bicells. By way of example, thin sheets composed of polyolefins or the already mentioned PVDF-HFP may be used as separators.

The electrode sheets are generally applied centrally to the separator, as a result of which the separator has a free edge area which is not covered by electrode material.

A plurality of individual cells or bicells can then be arranged in layers to form the already mentioned cell stack, which is processed by insertion into a housing, for example into a housing composed of deep-drawn aluminum composite foil, filling with electrolyte, sealing of the housing and final formation to produce a complete battery.

The metallic collectors of the electrodes are normally provided with output lugs which are in turn welded to an output conductor which is passed through the housing to the exterior. The output lugs in this case normally overlap the free edge area, which has been mentioned, of the separator, and can make contact with it.

It is preferable for the output lugs to be folded closely together and to be folded around together with the welded-on output conductor to save space and achieve a high energy density in the galvanic element.

Particularly when forming a cell stack from individual cells, the subsequent folding processes and the insertion of the cell stack into a housing, it is, however, possible for a separator of one individual cell to be pierced or at least damaged by parts of the output lugs, such as stamping and cutting burrs which occur in the edge area of the output lugs, bent areas of the output lugs or, in the case of output lugs composed of metal mesh, by individual metal-mesh webs which can be created, for example, by stamping out the electrode.

This can lead to direct contact between electrodes of opposite polarity and thus to an internal short circuit (a so-called “shoftshort”) in an individual cell, which leads to the entire cell stack becoming unusable.

Since, in recent years, ever thinner separators have been used to increase the energy density, in particular in lithium-polymer cells, the number of internal short circuits that occur has been increasing to an ever greater extent.

It could therefore be helpful to improve protection against short circuits of galvanic elements of the type mentioned above.

### SUMMARY

We provide a galvanic element including at least one individual cell having electrodes arranged on a substantially flat separator, at least one of which has a current collector provided with an output lug overlapping an edge area of the separator, with at least one thin layer being arranged in the edge area such that direct mechanical contact, is prevented between the output lug and the separator.

### BRIEF DESCRIPTION OF THE DRAWINGS

FIG. 1 shows a cross section (extract) of a prior art cell stack.

FIG. 2 shows, on the left, a prior art single individual cell.

FIG. 3 show, on the left, a positive electrode of one of our galvanic elements.

FIG. 4 shows, on the left, another positive electrode of a galvanic element.

FIG. 5 shows an individual cell of a galvanic element.

FIG. 6 shows an individual cell of a galvanic element.

### DETAILED DESCRIPTION

Further features will become evident from the following description of preferred structures and figures. In this case, the individual features may each be implemented in their own right or combined with one another in groups of two or more. The described constructions and examples are intended only for explanatory purposes and to assist understanding, and in no way should be understood as being restrictive.

The galvanic element comprises at least one individual cell having electrodes which are arranged on a flat, preferably very thin, separator. At least one of the electrodes has a current collector which is provided with an output lug which overlaps an edge area of the separator.

The galvanic element is distinguished in particular in that it is protected against internal short circuits mentioned above.

For this purpose, it is preferable to have at least one thin layer in the edge area in which the output lug overlaps the separator. This is arranged in particular such that at least direct mechanical contact is prevented between the side edges of the output lug and the separator. The at least one thin layer may be arranged such that the contact between the output lug and the separator is prevented not only in the area of the side edges of the output lug, but entirely. The output lug and the separator can then not touch.

Furthermore, it may be preferable for a galvanic element to have a separator for this purpose, which is bent over in the edge area. Together with the bent-over part, the separator forms a reinforced edge area, with which the output lug overlaps.

It may also be preferable for a galvanic element to have a separator which is thicker in the edge area than in the area in which the electrodes are fitted on the separator.

Both the at least one thin layer and the bent-over separator and/or the separator which is thicker at the edge area therefore lead to piercing of the separator by those parts of the output lugs mentioned above in the edge area being made at least considerably more difficult, if not even completely prevented. The options may, of course, also be combined with one another.

In one preferred galvanic element, the at least one thin layer is arranged between the output lug and the separator. In this case, it may be in the form of an elongated strip which at least partially, and preferably completely, covers the edge area of the separator in which the overlap with the output lug occurs, and reinforces it in the covered areas. Direct mechanical contact between the output lug and the separator in the edge area can thus be completely prevented.

However, it may also be preferable for the at least one thin layer to be arranged only in the areas between the separator and the output lug in which the side edges of the output lug can touch the separator.

The at least one thin layer can also be arranged such that it covers the side edges of the output lug to prevent a direct contact between the side edges of the output lug and the separator. For this purpose, it is, by way of example, in the form of an elongated strip which is bent over around the side edges of the output lug.

If the galvanic element has a separator which is bent over in the edge area, then this could be bent over both in the direction of the output lug and in the opposite direction. The bent-over part of the separator forms a double-layered, preferably elongated, area with the separator. By being bent over, the separator is reinforced in its entirety in the resultant double-layered area and can correspondingly be pierced less easily by sharp-edged or pointed objects.

An adhesive layer may be arranged between the bent-over part of the separator and the separator. The adhesive layer may be arranged over the complete area or at a point or points between the bent-over part and the separator.

The bent-over part of the separator can be at least partially, but preferably completely, fused to the separator. The bent-over part of the separator and the separator in the latter case preferably form a unit. The galvanic element may thus have a separator which is thicker in the edge area, in which the output lug overlaps the separator, than in the other areas, particularly in comparison to those areas in which the electrodes are arranged on the separator.

It is, of course, also possible to use a separator which has already been provided with a thicker edge area during production. The thicker edge area then need not be first formed by bending over and adhesive bonding or fusing.

The at least one thin layer that is used may be chemically inert with respect to conventional components of a galvanic cell such as electrolytes composed of organic carbonates with lithium conductive salts such as LiPF₆ or LiBF₄. The at least one thin layer is preferably an electrically insulating layer. This is, of course, not absolutely essential, since the mechanical reinforcement is the primary factor.

The at least one thin layer is, in particular, a layer based on polymer.

Particularly preferably, the at least one thin layer is a sheet, in particular a sheet based on polyethylene, polypropylene, polyethyleneterephthalate, polyetheretherketone, polyacrylonitrile, polytetrafluoroethylene or polyimide. Each of these sheets can be provided with a scratch-resistant protective layer on one or both sides to achieve greater resistance to piercing. This scratch-resistant protective layer may, for example, be composed of epoxy resin and is preferably between about 1 μm and about 7 μm thick.

The at least one thin layer can be adhesively bonded to the separator and/or to the output lug, in particular using an adhesive based on silicone, acrylate or a polar-modified polyolefin. The same adhesives are in general also suitable as an adhesive layer for adhesive bonding of the separator to the bent-over part of the separator, as mentioned above.

The at least one thin layer may also be produced from an adhesive, in particular a fusion adhesive. By way of example and depending on the desired structure, this may be applied in the form of an elongated strip to the edge area of the separator or to the side edges of the output lug.

The fusion adhesive is preferably a fusion adhesive based on polyolefin.

An adhesive has the advantage that it can easily and flexibly be applied as a thin layer. The application of the at least one thin layer to a separator or to the side edges of the output lug as an adhesive can thus be integrated particularly well in a process for production of a galvanic element of the abovementioned type.

The at least one individual cell is, in particular, a bicell. This preferably has a sequence of negative electrode/separator/positive electrode/separator/negative electrode or of positive electrode/separator/negative electrode/separator/positive electrode.

Separators which can be used in a galvanic element are preferably composed essentially of at least one polyolefin. The at least one polyolefin may, for example, be polyethylene. Multilayer separators can particularly preferably also be used, for example separators composed of a sequence of polyolefin layers, for example with the sequence polyethylene/polypropylene/polyethylene. However, in principle, other polymer-based materials may also be used as materials for separators in galvanic elements, for example, also and in particular PVDF-HFP as already mentioned initially.

It is preferable for a galvanic element to have at least one individual cell with at least one lithium-intercalating electrode. The galvanic element is particularly preferably a lithium-ion cell or a lithium-polymer cell.

The galvanic element preferably has at least one individual cell with at least one positive electrode which has lithium cobalt oxide (LiCoO₂) as the active material.

It is also preferable for a galvanic element to have at least one individual cell with at least one negative electrode which has graphite as the active material.

The galvanic element may have at least one individual cell with at least one positive electrode with lithium cobalt oxide as the active material and at least one negative electrode with graphite as the active material, with the individual cell then preferably having a sequence of negative electrode/separator/positive electrode/separator/negative electrode or of positive electrode/separator/negative electrode/separator/positive electrode.

A galvanic element preferably has at least one electrode with a current collector and an output lug composed of aluminum, in particular composed of aluminum metal mesh or of perforated aluminum foil. The at least one electrode with an aluminum collector or output lug is, in particular, the positive electrode.

Furthermore, in particular, a galvanic element has at least one electrode with a current collector and an output lug composed of copper, in particular composed of unperforated copper foil. The at least one electrode with a copper collector and output lug is, in particular, the negative electrode.

The electrodes of a galvanic element may be laminated onto the separator. The lamination process is preferably carried out at high temperatures and under pressure. The temperatures must in this case be matched in particular to the separator, which should not melt or shrink during the lamination process.

The separators which can preferably be used in a galvanic element preferably have a thickness of from about 3 μm to about 50 μm, in particular from about 10 μm to about 30 μm, and particularly preferably from about 12 μm to about 18 μm. They can be reinforced in the edge area, in which case their thickness in this area is then preferably approximately doubled.

The electrodes of a galvanic element preferably have a thickness of from about 50 μm to about 200 μm, in particular from about 70 μm to about 160 μm. The stated values in this case relate to “finished” electrodes, that is to say electrodes which have been provided with a corrector with an output lug.

The collectors and the output lugs of a galvanic element preferably have a thickness of from about 5 μm to about 50 μm, in particular from about 7 μm to about 40 μm. In particular, a thickness in the range from about 10 μm to about 40 μm is preferred for collectors and output lugs composed of aluminum. A thickness in the range from about 6 μm to about 40 μm is particularly preferable for collectors and output lugs composed of copper.

The at least one thin layer particularly preferably has a thickness which is not greater than the thickness of the electrodes. This means that the at least one thin layer does not change the maximum thickness of a cell stack composed of bicells, and therefore the energy density of a galvanic element.

A galvanic element generally has an electrolyte, in particular a mixture of ethylenecarbonate and diethylcarbonate with at least one'lithium conductive salt.

Furthermore, a galvanic element may have a housing composed of a composite sheet, which comprises at least one metal foil and is preferably coated with insulating material on the inside.

Surprisingly, it has been found that galvanic elements not only have advantages over conventional cells in terms of better short-circuit protection, in particular in the edge area of the separator. This is because it has been found that galvanic elements also have lower formation losses than comparable conventional elements during first charging and discharging. Furthermore, surprisingly, they also maintain their voltage better than comparable conventional galvanic elements during relatively long-term storage. It is assumed that the reason for this is that a creeping discharge takes place via those points (in particular in the aluminum/output conductor area) which are latently at risk of short circuits in the galvanic elements when using a convention design while, in the case of the galvanic elements, the at least one thin layer that is applied and/or the folded-over separator which has two layers in the area at risk and/or is thicker in the edge area cannot be passed through, or cannot be passed through as well, by the voltage.

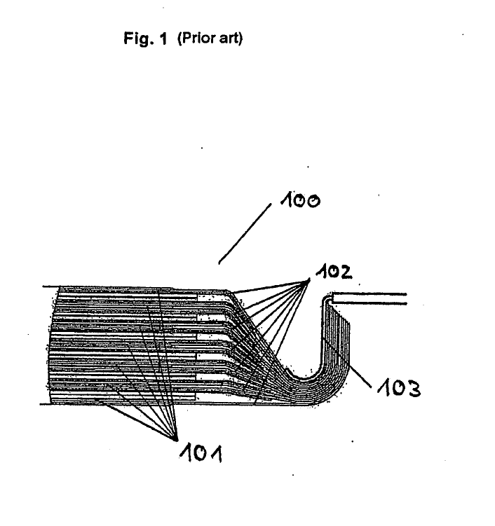

FIG. 1 shows a cross section (extract) of a prior art cell stack comprising a plurality of individual cells 101. One cell stack 100 has a plurality of individual cells 101 with folded-together output lugs 102 and an output conductor 103 welded thereto. The output conductor 103 is passed out of the housing (not shown) in the finished galvanic element, and forms the external contact. The output conductor 103 is folded over together with the welded-on output lugs 102 to save space and thus to increase the energy density of the galvanic element.

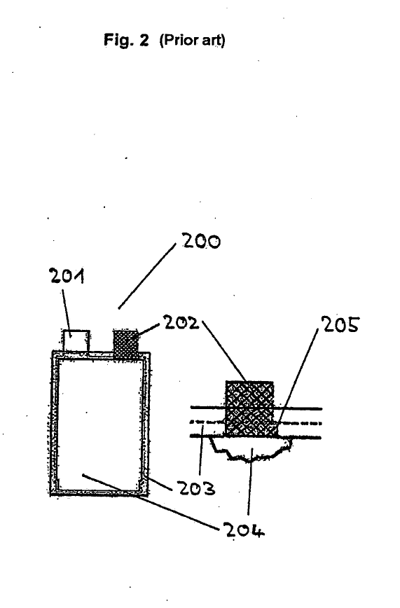

FIG. 2 shows, on the left, a prior art single individual cell with an output lug in the form of a copper foil 201 and an output lug composed of aluminum metal mesh 202. Electrodes are arranged on both sides of a separator, of which only the edge area 203 can be seen, and of which electrodes only the positive electrode 204 can be seen. On the right, FIG. 2 shows an enlarged detail of the individual cell 200 illustrated on the left. This shows the output lug 202, the edge area of the separator 203 and a part of the positive electrode 204. A metal mesh web 205 can be seen on the side edge of the output lug 202 and may be formed, for example, by stamping out the electrode. Because of this metal mesh web, the separator can be damaged or pierced, for example when forming the layers of a cell stack, when folding the conductor lugs together or during insertion of the cell stack into a housing, as a result of which a short circuit can occur.

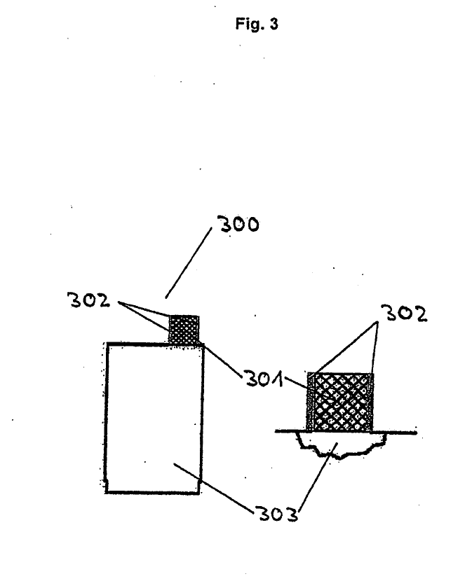

FIG. 3 shows, on the left, a positive electrode of one of our galvanic elements with a collector (which cannot be seen) with an output lug 301 composed of aluminum metal mesh, whose side edges are each covered by a plastic film or a layer composed of fusion adhesive as thin layers 302, and which is folded around the side edges of the output lug, and with the electrode film 303. On the right, FIG. 3 shows a detail of the electrode 300 illustrated on the left. This shows a part of the electrode film 303, the output lug 301 composed of aluminum metal mesh and the thin layers 302 which cover the side edges of the output lug. Any individual metal mesh webs which may be present, and as are illustrated in FIG. 2, are covered by the thin layers 302 and cannot pierce or damage an adjacent separator (not illustrated).

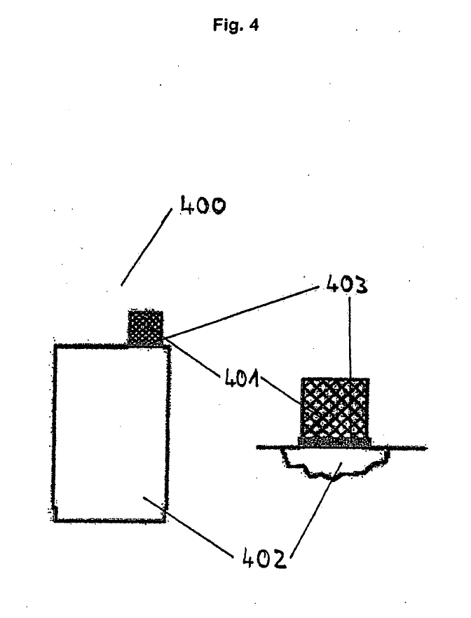

FIG. 4 shows, on the left, another positive electrode of a galvanic element with a collector (which cannot be seen) with an output lug 401 composed of aluminum metal mesh and with the electrode film 402. A thin layer 403 is arranged transversely with respect to the direction of the output conductor, along the edge of the electrode film 402. On the right, FIG. 3 shows a detail of the electrode 400 illustrated on the left. This shows a part of the electrode film 402, the output lug 401 composed of aluminum metal mesh and a thin layer 403. If the electrode 400 is arranged centrally on a separator (not illustrated), then the thin layer 403 protects the edge area of the separator against damage.

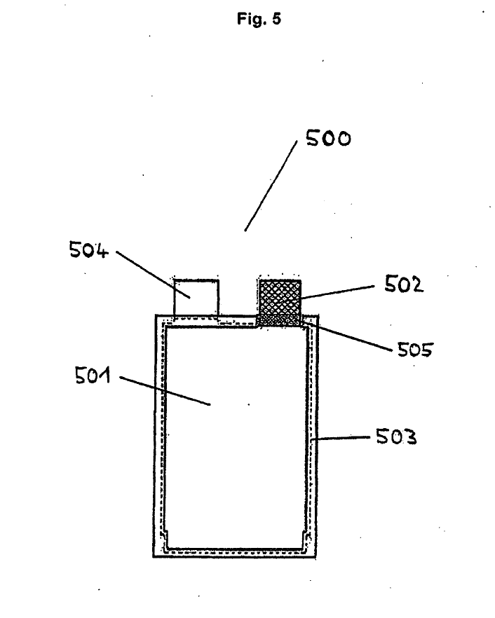

FIG. 5 shows an individual cell of a galvanic element with a positive electrode 501 which has a current collector (which cannot be seen) with an output lug 502 composed of aluminum metal mesh, a separator 503, of which only the edge area can be seen, and an output lug 504 composed of a massive copper foil, which is connected to the current collector of the negative electrode. The negative electrode and the associated current collector are located on the lower face of the separator (which cannot be seen). A plastic sheet or a layer composed of fusion adhesive is arranged as a thin layer 505 in the edge area of the separator 503 such that this prevents direct mechanical contact between the output lug 502, in particular of the side edges of the output lug 502, and the edge area of the separator 503, where the output lug 502 overlaps it.

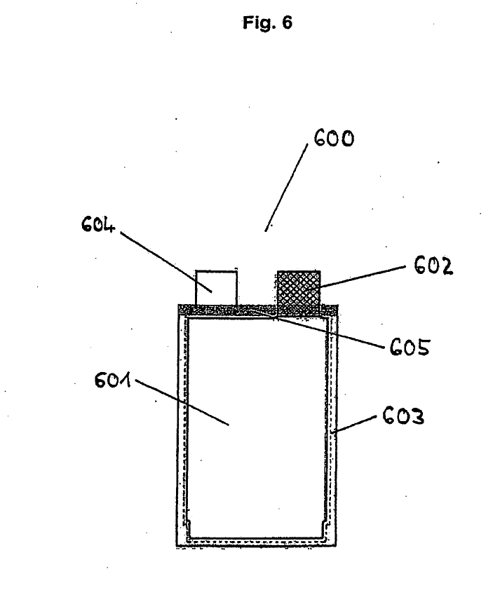

FIG. 6 shows an individual cell of a galvanic element with a positive electrode 601 which has a current collector (which cannot be seen) with an output lug 602 composed aluminum metal mesh, a separator 603, of which only the edge area can be seen, and an output lug 604 composed of a massive copper foil which is connected to the current collector of the negative electrode. The negative electrode and the associated current collector are located on the lower face of the separator 603 (which cannot be seen). A plastic sheet or a layer composed of fusion adhesive is arranged as a thin layer 605 in the edge area of the separator 603 such that this prevents direct mechanical contact between the output lug 602, in particular the side edges of the output lug 602, and the edge area of the separator 603, where the output lug 602 overlaps it.

### EXAMPLES

### I. Production of One Representative Galvanic Element.

(1) Production of a negative electrode

200 ml of acetone is placed in a 500 ml plastic container. 24.75 g of a PVDF-HFP copolymer (Kynar Powerflex® from Elf Atochem) with a proportion of HFP of 6% by weight is dissolved therein. This is raised to a temperature of about 40° C. by means of a water bath and is stirred using a laboratory stirrer (Eurostar IKA®). As soon as this results in a clear solution, 7.1 g of carbon black is introduced to improve the conductivity. After 10 minutes, 321.8 g of graphite MCMB 25-28 are introduced in small portions; the mixture is then stirred for one hour at 1700 rpm.

The coating compound produced in this way is then applied as a film with a weight per unit area of about 15.4 mg/cm² on both sides to a collector formed by a 12 μm-thick copper foil.

(2) Production of a positive electrode

250 ml of acetone is placed in a 500 ml plastic container. 21.70 g of a PVDF-HFP copolymer (Kynar Powerflex® from Elf Atochem with a proportion of HFP of 6% by weight) is dissolved therein. After a clear solution has been obtained, 3.1 g of conductive carbon black and 3.1 g of graphite are added to improve the conductivity. After a short time, 276.2 g of lithium cobalt oxide is added in portions, with intensive stirring.

The coating compound that is produced is wiped as a film onto Mylar® carrier film with the aid of a SCIMAT film drawing appliance (weight per unit area approx. 20 mg/cm²). This electrode film is then laminated on both sides on a collector composed of aluminum metal mesh.

(3) Production of bicells

For one representative galvanic element, bicells are manufactured from negative electrodes produced in'accordance (1) and positive electrodes produced in accordance with (2).

For this purpose, strips are in each case stamped out of the negative electrodes from (1) and the positive electrodes from (2). These are then prefabricated to form bicells (positive electrode/separator/negative electrode/separator/positive electrode). To do this, one separator (three layers composed of polypropylene/polyethy-lene/polypropylene) are first of all each applied to the two sides of a negative electrode, preferably by lamination. In a second step, the upper and the lower positive electrode are then each applied centrally to the free faces of the separators, likewise preferably by lamination. A peripheral edge area of the separators in this case remains free of electrode material, and in each case overlaps the output lugs of the positive electrode in a sub-area.

(4) In the next step, a polyimide strip (Kapton®) is adhesively bonded by means of a polyacrylate adhesive onto the edge area of the separator of a bicell produced in accordance with (3). The polyethylene strip is in this case arranged in the overlap area between the output lug and the separator such that the output lug can no longer touch the separator (see FIG. 5).
(5) Twelve bicells provided with polyimide strip in accordance with (4) are placed in layers to form a cell stack. This is inserted into a housing formed from deep-drawing aluminum composite foil. This is then filled with electrolyte, the housing is sealed, and a final formation process is carried out.

The galvanic element that is produced has a length of 41 mm, a width of 34 mm and a height of 4.4 mm.

(6) Several hundred samples of a galvanic element produced in accordance with (5) were produced in one production test round. In this case, there was no wastage resulting from an internal short circuit in the edge area of the separator.
II. Formation tests were carried out using a galvanic element produced in accordance with I. The galvanic element was charged with a specific amount of energy, and was then discharged again. The transferred amounts of energy during charging and discharging were in each case measured.

In this case, surprisingly, a higher formation loss was measured in conventional cells (analogously to I.-produced cells, but without the polyimide strip applied in step (4)) than in the case of galvanic elements. In the case of conventional cells, the formation loss is approximately 10%, while the cells have reduced formation losses of approximately 8%.

The results of the respective measurements are summarized in Table 1:

TABLE 1
Formation losses

| | First | | |
|---|---|---|---|
| Design | charge [Ah] | First discharge [Ah] | Formation loss [%] |
| Conventional | 0.674 | 0.607 | 10 |
| cell | | | |
| Galvanic | | | |
| element | 0.664 | 0.609 | 8 |
| in accordance | | | |
| with I. | | | |

As has already been indicated, the reduction in the formation losses in galvanic elements could be a result of the voltage not being able to pass through, or being able to pass through to a far lesser extent, during the formation process at points (in particular in the aluminum/output conductor area) which are latently at risk of short circuits in the applied polyimide strips.

III. Galvanic elements produced in accordance with I were charged up to approximately 50% of their capacity. The elements were kept at room temperature and the voltage of the galvanic elements was measured at regular time intervals over a time period of several months.

In the case of conventional cells (analogously to I.-produced cells, but without the polyimide strips applied in step (4)) a voltage drop was found, in contrast to our galvanic elements (see Tables 2 and 3).

TABLE 2
Results of the voltage measurements

| | Voltage at | Voltage | Voltage | Voltage |
|---|---|---|---|---|
| | the start | after 14 | after 1 | after 3 |
| Design | of storage [V] | days [V] | month [V] | months [V] |
| Conventional cell | 3.890 | 3.850 | 3.820 | 3.800 |
| Galvanic element | 3.890 | 3.890 | 3.890 | 3.886 |
| in accordance | | | | |
| with I. | | | | |

As already mentioned above, we believe that the reason for this is that a creeping discharge takes place via those point (in particular in the aluminum/output conductor area) of the galvanic elements which are latently at risk of short circuits while, in the case of our galvanic elements, the voltage cannot pass through, or can pass through only to a far lesser extent, the applied polyimide strip.

The same experiments were carried out with virtually discharged galvanic elements at a correspondingly lower voltage. The results (summarized in Table 3) were comparable. In this case as well, a reduced voltage drop, or no voltage drop at all, was observed in the case of our galvanic elements.

TABLE 3
Further results of the voltage measurements

| | Voltage at | Voltage | Voltage | Voltage | Difference |
|---|---|---|---|---|---|
| | the start | after | after | after | of voltage |
| Design | of experiment [V] | 1 h [V] | 2 h [V] | 5 h [V] | [mV] |
| Conventional | 2.890 | 2.890 | 2.889 | 2.885 | 5.0 |
| cell | | | | | |
| Galvanic | 2.890 | 2.890 | 2.890 | 2.890 | 0.0 |
| element in | | | | | |
| accordance | | | | | |
| with I. | | | | | |

1-18. (canceled)

19. A galvanic element, comprising at least one individual cell having electrodes arranged on a substantially flat separator, at least one of which has a current collector provided with an output lug overlapping an edge area of the separator, with at least one thin layer being arranged in the edge area such that direct mechanical contact is prevented between the output lug and the separator.

20. The galvanic element as claimed in claim 19, wherein the at least one thin layer is arranged between the output lug and the separator.

21. The galvanic element as claimed in claim 19, wherein the at least one thin layer covers the side edges of the output lug.

22. The galvanic element as claimed in claim 19, wherein the at least one thin layer is a polymer layer.

23. The galvanic element as claimed claim 19, wherein the at least one thin layer is a sheet.

24. The galvanic element as claimed in claim 23, wherein the sheet is adhesively bonded to the separator.

25. The galvanic element as claimed in claim 23, wherein the sheet is adhesively bonded to the output lug.

26. The galvanic element as claimed claim 19, wherein the at least one thin layer is a sheet composed of polyethylene, polypropylene, polyethyleneterephthalate, polyetheretherketone, polyacrylonitrile, polytetrafluoroethylene or polyimide.

27. The galvanic element as claimed in claim 19, wherein the at least one thin layer is produced from an adhesive.

28. The galvanic element as claimed in claim 19, wherein the at least one thin layer is produced from a fusion adhesive.

29. The galvanic element as claimed in claim 28, wherein the adhesive is a fusion adhesive based on polyolefin.

30. The galvanic element as claimed in claim 19, wherein the at least one individual cell is a bicell.

31. The galvanic element as claimed in claim 19, wherein the at least one individual cell comprises a sequence of negative electrode/separator/positive electrode/separator/negative electrode.

32. The galvanic element as claimed in claim 19, wherein the at least one individual cell comprises a sequence of positive electrode/separator/negative electrode/separator/positive electrode.

33. The galvanic element as claimed in claim 19, wherein the separator is composed essentially of at least one polyolefin.

34. The galvanic element as claimed in claim 19, wherein at least one of the electrodes of the at least one individual cell is a lithium-intercalating electrode.

35. The galvanic element as claimed in claim 19, wherein the at least one individual cell has at least one positive electrode which has LiCoO₂ as active material.

36. The galvanic element as claimed in claim 19, wherein the at least one individual cell has at least one negative electrode which has graphite as active material.

37. The galvanic element as claimed in claim 19, wherein the galvanic element has at least one electrode with a current collector and an output lug composed of aluminum.

38. The galvanic element as claimed in claim 37, wherein the current collector and the output lug are composed of an aluminum metal mesh or of a perforated aluminum foil.

39. The galvanic element as claimed in claim 19, wherein the galvanic element has an electrode with a current collector and an output lug composed of copper.

40. The galvanic element as claimed in claim 39, wherein the current collector and the output lug are composed of unperforated copper foil.

41. The galvanic element as claimed in claim 19, wherein the electrodes are laminated onto the separator.

42. The galvanic element as claimed in claim 19, wherein the galvanic element has, as electrolyte, a mixture composed of ethylenecarbonate and diethylcarbonate with at least one lithium conductive salt.

43. The galvanic element as claimed in claim 19, further comprising a housing composed of a composite sheet, which comprises at least one metal foil and, has an inner insulating coating material.
